(19) United States
(12) Patent Application Publication
(10) Pub. No.: US 2017/0295276 A1
(43) Pub. Date: Oct. 12, 2017

(54) METHOD FOR DYNAMICALLY CHANGING USER INTERFACE ELEMENTS

(71) Applicant: Futurewei Technologies, Inc., Plano, TX (US)

(72) Inventors: Hao Wang, San Diego, CA (US); Chukwuchebem Orakwue, San Diego, CA (US); Tongzeng Yang, San Diego, CA (US)

(21) Appl. No.: 15/095,749

(22) Filed: Apr. 11, 2016

(51) Int. Cl. H04M 1/725; H04W 52/02

(52) U.S. Cl. CPC H04M 1/72519; H04W 52/0251

(57) ABSTRACT

A method includes detecting, via a controller, a change in condition of an electronic device, and selecting, via the controller, a subset of elements of a graphical user interface (GUI) of a display of the electronic device to be modified. The controller dynamically modifies the selected GUI elements globally for one or more applications of the GUI, and renders an output on the display using the modified GUI elements to provide eye relief for a user of the electronic device and preserve electrical power for the electronic device.

### TECHNICAL FIELD

The present application is related to user interfaces for electronic devices and systems, and in particular to a method for dynamically changing graphical user interface (GUI) elements.

### BACKGROUND

Electronic devices provide GUI with icons as a visual symbol of a link or shortcut to an application performable by the electronic device. Modern operating systems provide the GUI for interactions with the device and for display of processed user requests. Clicking on an icon with a computer mouse or touching the icon displayed on a touchscreen display starts one predefined task or function, such as launching a client application linked to the icon.

Due to changing environmental conditions around the display, dynamically changing attributes such as color or brightness of GUI elements is desirable to lower eye strain and power usage, but doing this in real-time can be challenging. Most present devices achieve this by applying color transformations on all composited content, but this can negatively alter visual appearance of images. In another technique, GUI elements of an application may be updated by loading different GUI configurations in response to changing environmental conditions. However, reloading a GUI configuration for an application would require the application to be restarted which compromises user experience. Thus, there is a need for improvement to user interfaces of electronic devices.

### SUMMARY

Methods, apparatus and machine storage media are provided that dynamically change graphical user interface (GUI) elements for purposes of reducing eye strain and preserving device power. In one aspect, a method includes detecting, via a controller, a change in condition of an electronic device, and selecting, via the controller, a subset of elements of a GUI of a display of the electronic device to be modified. The controller dynamically modifies the selected GUI elements globally for one or more applications of the GUI, and renders an output on the display using the modified GUI elements, to provide eye relief for a user of the electronic device and preserve electrical power for the electronic device.

Another aspect provides an electronic device including a display screen configured to provide a GUI, a sensor configured to generate an indication representative of a change in environment condition about the electronic device, and a processor circuit electrically coupled to the display screen and the sensor. The processor circuit is configured to receive the indication of a change in condition of the electronic device from the sensor, and select a subset of elements of the GUI of the electronic device to be modified. In various embodiments, the processor is further configured to dynamically modify the selected GUI elements globally for one or more applications of the GUI, and render an output on the display screen using the modified GUI elements, to provide eye relief for a user of the electronic device and preserve electrical power for the electronic device.

A computer readable storage medium is provided that includes instructions for execution by a processor to detect a change in condition of the electronic device, select a subset of elements of a GUI of a display of the electronic device to be modified, dynamically modify the selected GUI elements globally for one or more applications of the GUI, and render an output on the display using the modified GUI elements, to provide eye relief for a user of the electronic device and preserve electrical power for the electronic device.

### BRIEF DESCRIPTION OF THE DRAWINGS

FIG. 1A illustrates an unmodified GUI on an electronic device.

FIG. 1B illustrates a modified GUI on an electronic device, according to an example embodiment.

FIG. 2A illustrates an unmodified GUI on an electronic device.

FIG. 2B illustrates a GUI on an electronic device as modified according to an example.

FIG. 2C illustrates a modified GUI on an electronic device, according to an example embodiment.

FIGS. 3A-3D illustrate a GUI as modified for time of day, according to an example embodiment.

FIG. 4 is a block flow diagram illustrating elements configured to dynamically change GUI elements, according to an example embodiment.

FIG. 5 is a flowchart illustrating a method for dynamically changing GUI elements, according to an example embodiment.

FIG. 6 illustrates a table of elements of a GUI that can be changed dynamically, according to example embodiments.

FIGS. 7A-7B are graphs illustrating power savings for dynamically changing GUI elements, according to an example embodiment.

FIG. 8 is a block diagram illustrating circuitry for implementing devices to perform methods, according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention to be interpreted broadly, as defined by the appended claims.

The functions or algorithms described herein may be implemented in software or a combination of software and human implemented procedures in one embodiment. The software may be in the form of computer executable instructions stored on computer readable media or computer readable storage devices such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. Various embodiments include more than one controller in the wireless network and include distributed processing to perform the present subject matter.

In various embodiments, power consumption for an electronic device is reduced and eye strain for a user of the electronic device is lowered by dynamically modifying attributes of GUI elements. The modification of GUI elements is done globally and at runtime without having to reboot applications, in various embodiments. In addition, the present subject matter provides an attribute associated with the GUI element that is tagged to indicate if and how the GUI element will be dynamically changed, in further embodiments. Thus, an application developer could have the flexibility to customize how individual GUI elements of an application respond to changes in ambient conditions. Additional information regarding the type of modification for the GUI element may be stored with the attribute, in various embodiments.

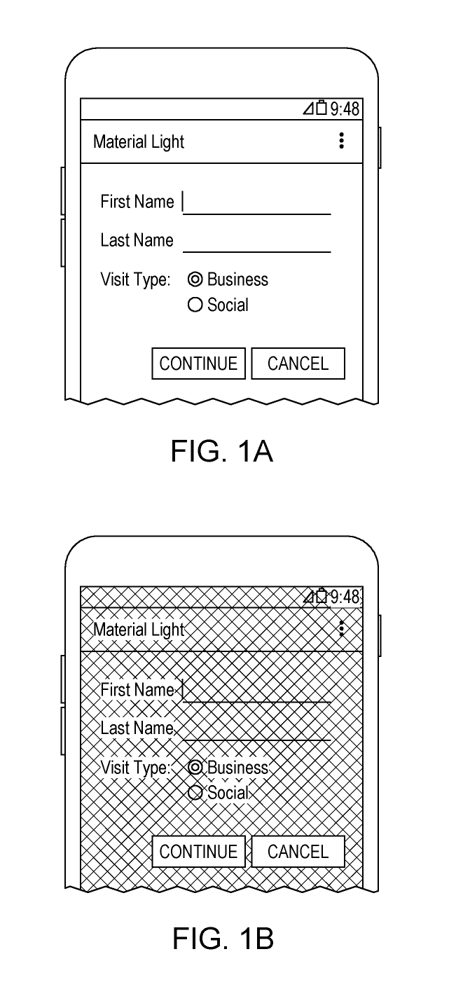

FIG. 1A shows an unmodified display on an electronic device, such as a cellular telephone, and FIG. 1B shows the same display after modification by the present subject matter to change text and background color. The present subject matter provides a method to dynamically modify one or more attributes for GUI elements such as color or contrast at runtime without applying global transformation or need to restart or reboot applications. For devices with emissive displays such as organic light-emitting diode (OLED) where power consumption depends on displayed content, this method can improve energy consumption without compromising user experience. In addition, modifying GUI elements in this manner can reduce eye strain and help improve user experience.

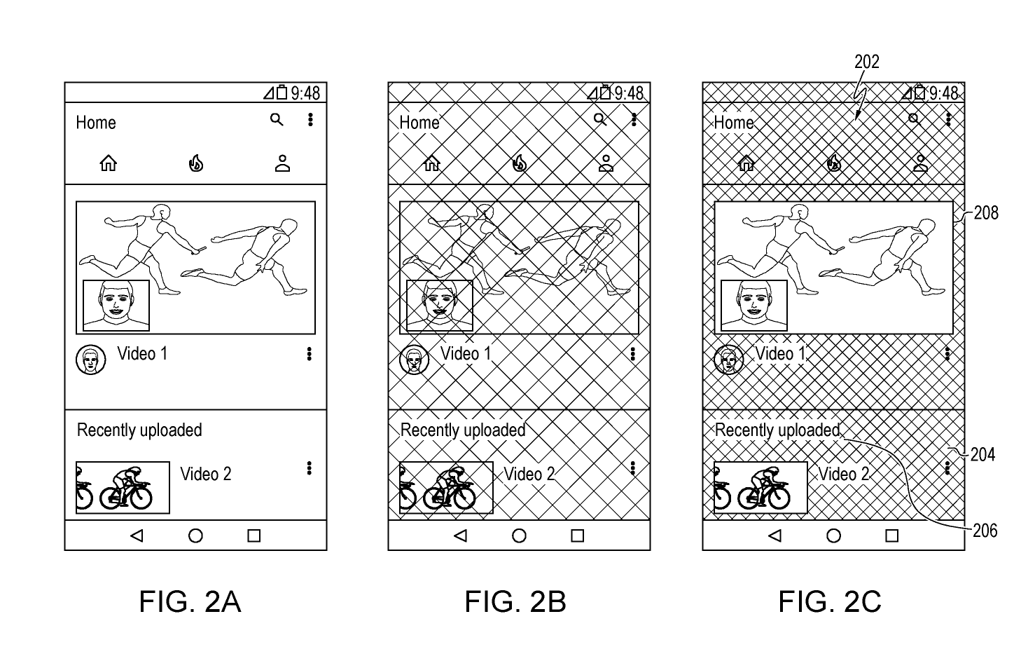

FIG. 2A illustrates a GUI on a display of an electronic device. Different elements of the GUI may be generated by an operating system or other code executing on the device, such as applications. FIG. 2C illustrates a GUI on an electronic device with select elements modified, according to an example embodiment. In the depicted embodiment, the upper home portion 202 is modified to a darkened shade of the same color, while the image 208 was not modified. In addition, the background 204 and text 206 of the lower portion were modified to be less stark and glaring, saving energy. The net effect is to reduce contrast between elements and reduce the number of bright elements, except for instance, where it would distort an image.

Previous solutions change a color temperature of content being displayed on a display from cold to warm, or yellow, based on geo-location and time, but is applied on a frame buffer so everything on the display will become yellow. Color temperature of a light source is the temperature of an ideal black-body radiator that radiates light of comparable hue to that of the light source. FIG. 2B illustrates a GUI on an electronic device as modified from the GUI of FIG. 2A, utilizing a yellow filter to yellow the display. However, having a yellow filter on the display gives the user a negative visual experience, especially when browsing pictures or watching videos. The present subject matter provides a method to selectively change GUI elements at runtime without sacrificing user experience, as shown in FIG. 2C where the net effect of select dynamic modification reduces contrast between elements and reduces the number of bright elements, except where it would distort an image. Examples of modified GUI elements include color, contrast, font, themes/styles etc.

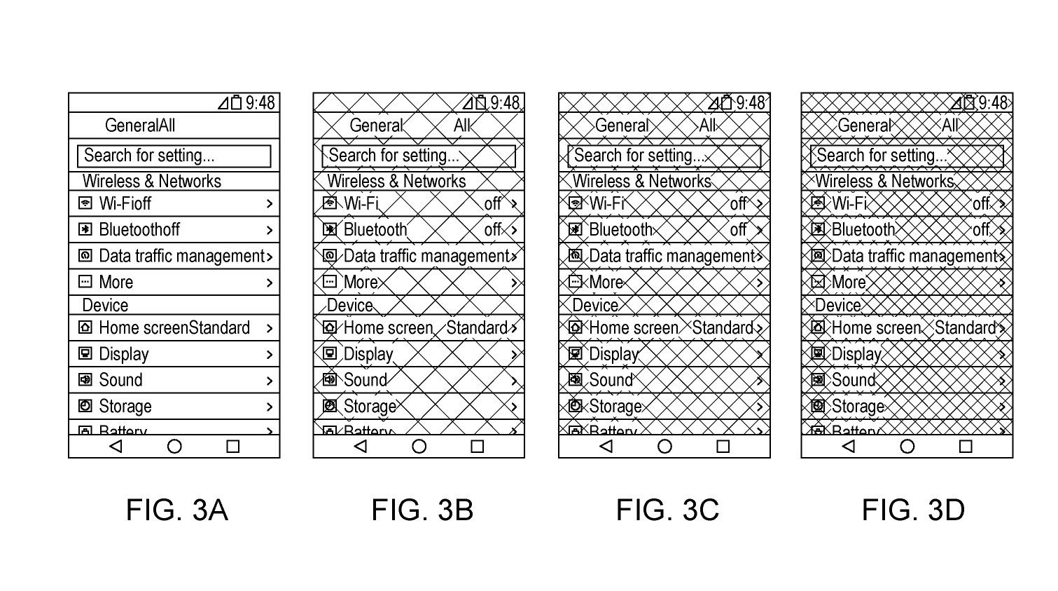

FIGS. 3A-3D illustrate a GUI as modified for time of day, according to an example embodiment. FIG. 3A shows a display in the morning, with unchanged settings and GUI elements. FIG. 3B shows the display during the daytime, with GUI elements slightly modified using the present subject matter. FIG. 3C shows the same display at dusk, further darkening the display using the present algorithm. FIG. 3D shows the display at night, with further changes to the GUI elements for eye relief and power saving, in various embodiments.

In various embodiments, an attribute is added to predefined GUI elements in the operating system (OS). Select GUI elements (having a dynamic change attribute=true) are modified before rendering the image on a display of the electronic device to a user. These adjustments to GUI elements are applied globally by the OS for all visible applications on the GUI. In various embodiments, reasons for runtime GUI modification can include, but are not limited to, transition in time of day, geographical location changes, device operating or power mode changes, and/or an explicit request by the user. For instance, to improve readability and reduce eye fatigue, the present subject matter can change GUI elements for an email application having the dynamic change attribute=true while leaving embedded images having the dynamic change attribute=false unchanged. In various embodiments, the present subject matter transforms the GUI elements before rendering or compositing to the display. The present subject matter is OS-based and applicable globally to select GUI elements of all applications, in various embodiments. Thus, the present subject matter is developer-agnostic, such that there is no need to write special code or provide additional computing resources.

The present subject matter improves user experience by executing at an increased speed over prior solutions, since re-launch of applications and reload of application resources is not required. Compared to current solutions that make all content yellowish or warmer, the present subject matter lowers eye strain, fatigue and overstimulation. In addition, the present subject matter can lower energy consumption in devices with emissive displays, such as OLED displays. In various embodiments, the present subject matter provides a new change attribute, or tag, associated with GUI elements to indicate if a dynamic change allowed. The OS reads the tag and performs selective adjustment of the GUI element if the tag is true, before rendering for GUI elements, in various embodiments. The dynamic change is applicable system-wide for GUI and all visible applications, in various embodiments. Restart and reload of applications is not required, and no additional hardware is required. The present subject matter enhances user experience while using electronic devices by lowering degree of eye strain, fatigue or overstimulation. In addition, the present subject matter can lower energy consumption and thus extend battery life in devices with OLED displays and other emissive displays where energy consumption is dependent on color of rendered content.

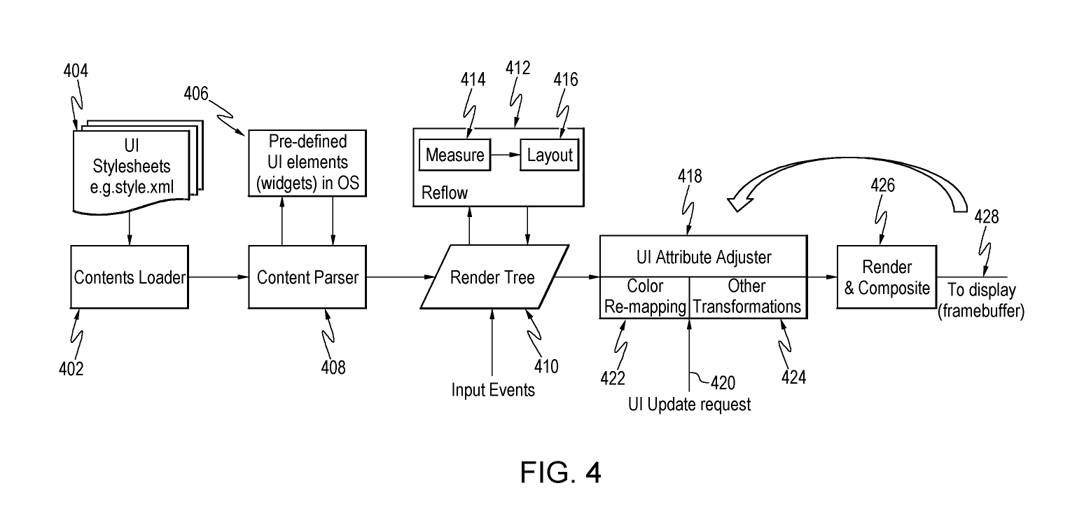

FIG. 4 is a block flow diagram illustrating elements involved in a method for dynamically changing GUI elements, according to an example embodiment. A content loader 402 loads contents and UI stylesheets from storage device 404. Predefined GUI elements 406 such as icons and widgets may include an attribute or tag that is set to indicate whether dynamic adjustment is allowed for the GUI element, in various embodiments. The elements are parsed at a content parser 408, and a reflow application 412 of the display recalculates positions, geometries and layout of GUI elements. This process includes measure 414 and layout 416 blocks that are processed for instance, in response to user interaction to the render tree 410 as highlighted by input events. The render tree 410 is used to compute the layout of each visible GUI element and serves as an input to the paint process which renders the pixels to screen. Before rendering, GUI elements from multiple applications can be combined together (composited) and then rendered to the screen. GUI attributes are dynamically modified using GUI attribute adjuster 418, which includes color remapping 422 and other transformations of GUI element(s) 424, based on a condition change, such as an update request 420 by user input or sensed change in environment (time, light, etc., from sensor 807 below) in various embodiments. In various embodiments, the GUI is rendered using render and composite application 426, and output to a display 428.

If the added attribute, or tag to a GUI element is has a first prescribed value, it indicates that dynamic adjustment of the GUI is allowed. In one example, the first prescribed value is ‘true’. Other prescribed values can be used without departing from the scope of the present subject matter. For instance, the added attribute or tag may include an indication of how the GUI element is to be modified depending on the ambient conditions or some other set of prescribed values. On request, the present subject matter can apply transformations to select GUI elements before rendering or compositing. In various embodiments, transforms such as color histogram mapping may be used to lighten or darken color, and the final attribute format can be different from the source format. The trigger for dynamic modification can be based on change in time of day, device operating mode, or user request. Other types of triggers can be used without departing from the scope of the present subject matter. In addition, the trigger for dynamic modification can be controlled by the value stored at the added attribute or tag, in various embodiments.

Thus, the present subject matter is superior to previous solutions in that that modifications are made before writing out the display to be rendered. In most electronic devices, elements shown to the user are written to a part of memory referred to as Frame Buffer (FB). Hence, a common trend in contemporary solutions is to make any adjustments to FB, before the display reads that memory and renders the image. However, the present subject matter makes these adjustments before the information is stored to the FB. In addition, the present subject matter makes changes globally by the OS for all applications, and thus developers do have to specially modify their applications. In various embodiments, if the condition change is detected, the GUI elements are that are tagged to be modified are changed and written to FB memory.

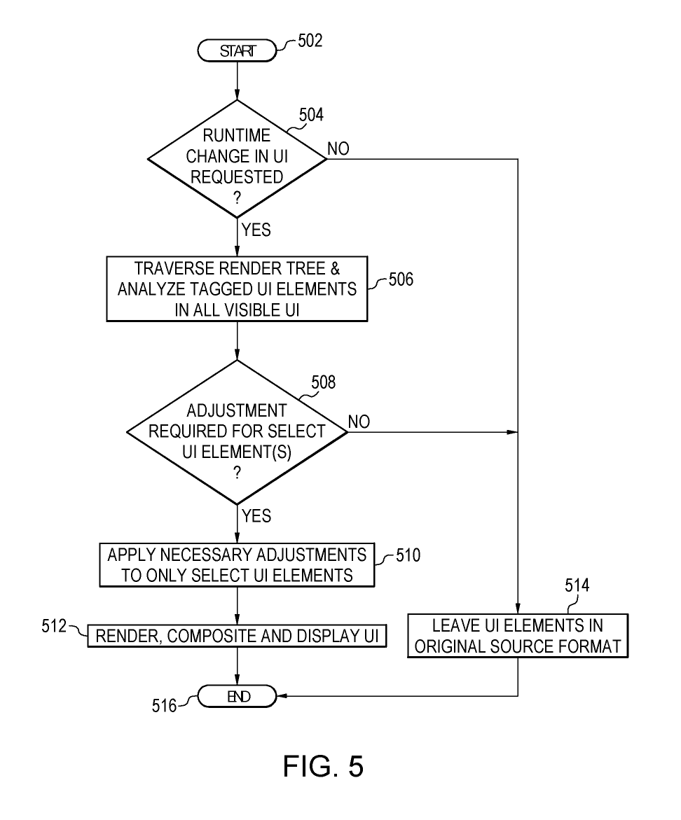

FIG. 5 is a flowchart illustrating a method for dynamically changing GUI elements, according to an example embodiment. The method starts at 502, and at 504 the processor checks whether a runtime change in GUI elements is requested or triggered. As stated above, the trigger for dynamic modification can be based on auto detected changes, change in time of day, device operating mode, user request, value stored in the tag attribute, or other type of sensed or stored parameters. If no change is requested or triggered, GUI elements are unchanged from their original source format at 514. If a runtime change is requested or triggered at 504, at 506 the render tree is traversed and tagged GUI elements are identified. At 508, if adjustment is indicated for a selected GUI element, the adjustments are applied at 510. Once all tagged GUI elements are dynamically modified, the resulting image is rendered on the GUI display at 512 and the method ends at 516, in various embodiments. To determine if dynamic adjustment is to be used, the present method can be based on relative relationships with other GUI elements, such as inheritance, or non-relative relationships in various embodiments. Thus, if a GUI element is lacking the attribute, an attribute value can be estimated from related GUI elements.

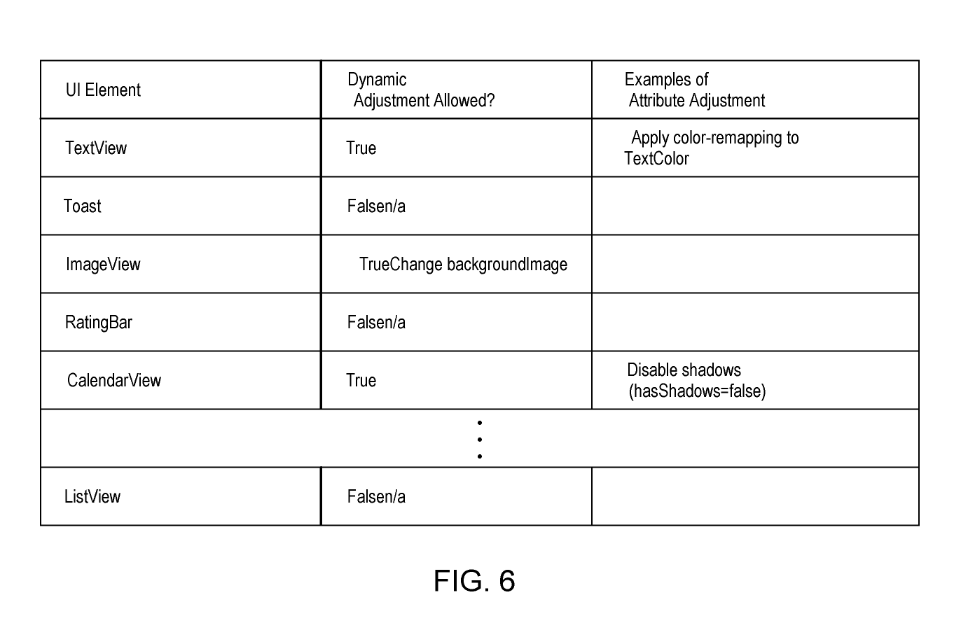

FIG. 6 illustrates a table of elements of a GUI that can be changed dynamically in one application, according to example embodiments. Different applications can be associated with different tables of elements, in various embodiments. In various embodiments, the tables can be used at the operating system level or for individual applications as desired. If the associated tag is set to true, the GUI element can be adjusted as indicated. For example, the GUI element TextView, which relates to how text is displayed on the GUI, can be modified or adjusted by applying color remapping. As shown in the depicted embodiment, different types of adjustments can be done for different GUI elements. The types of adjustments to be done for the GUI elements can be saved in memory along with the true/false attribute, in various embodiments. In some embodiments, the type of adjustment can be modified by a programmer and/or user. In another example, the GUI element ImageView relates to how images are displayed on the GUI, and changing backgroundlmage entails adjusting the color of a background to the image or images displayed on the GUI. In various embodiments, dynamic adjustment software of the present subject matter may identify GUI elements from a list of types of GUI elements, read the attributes associated with the identified GUI elements, and apply the corresponding attribute adjustment. For time-related adjustments shown in FIGS. 3A-3B, adjustments can be done at different levels of the GUI in various embodiments.

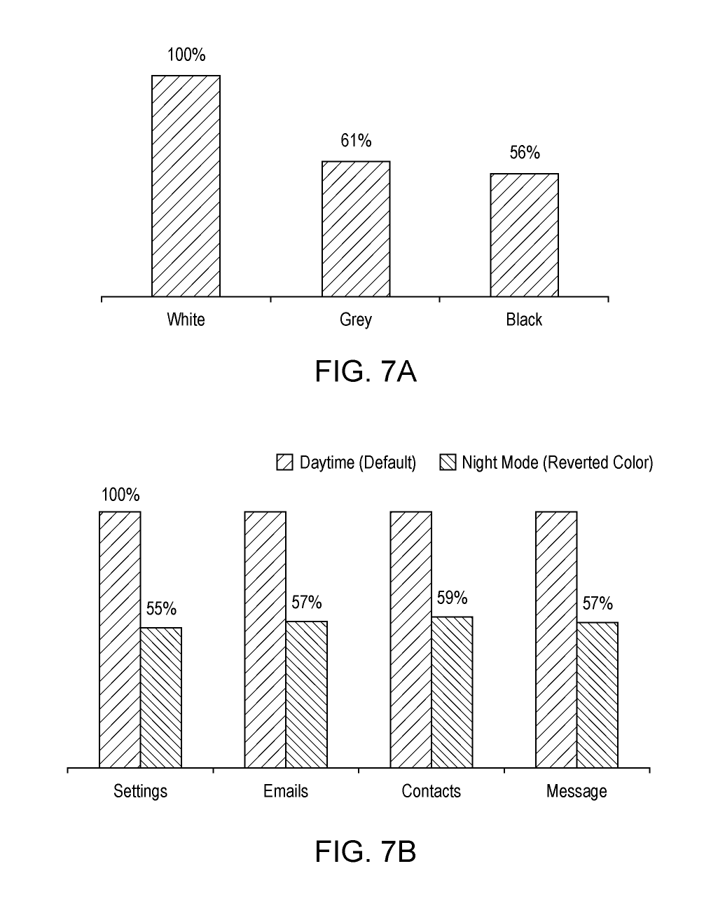

FIGS. 7A-7B are graphs illustrating power savings for dynamically changing GUI elements, according to an example embodiment. FIG. 7A shows the percentage of power used if the background of an application is changed from white to grey or black as measured on a commercial electronic device with an OLED display. FIG. 7B shows power savings for applications such as settings, email, contacts and messages when using a night mode with reverted color as compared to a regular daytime mode, in various embodiments.

The present subject matter provides for dynamically changing graphical user interface (GUI) elements for purposes of reducing eye strain and preserving device power. In one aspect, a method includes detecting, via a controller, a change in condition of an electronic device, and selecting, via the controller, elements of a GUI of a display of the electronic device to be modified. The controller dynamically modifies the selected GUI elements globally for one or more applications, and renders an output on the display using the modified GUI elements, to provide eye relief for a user of the electronic device and preserve electrical power for the electronic device.

In various embodiments, detecting a change in condition of the device includes receiving an input from a user requesting a change such as touching an icon on a display. In various embodiments, detecting a change in condition of the device includes sensing an ambient environmental parameter (such as light level, geographic location, etc.) using a sensor or from a signal received indicative of a sensed parameter. Other types of changes in condition can be detected without departing from the scope of the present subject matter.

According to various embodiments, selecting elements to be modified includes reading an attribute of the element to determine whether to modify the element. The attribute of the element is set to a first prescribed value if the element is to be modified, such as setting the attribute to “true” or to include an indication of how the element is to be modified under certain circumstances. The attribute of the element is set to a second prescribed value if the element is not to be modified, such as setting the attribute to “false.” Selecting elements to be modified includes selecting color of the display, contrast of the display, display font, display theme and/or display style. Other elements of a GUI can be modified without departing from the scope of the present subject matter.

In various embodiments, reading the attribute of the element includes determining how to dynamically modify the selected GUI elements. In some embodiments, a type of modification is stored with the attribute. Dynamically modifying the selected GUI elements includes applying color remapping to text and/or an image, changing a background of an image, or disabling shadows in an image, in various embodiments. Other types of dynamic modification can be processed without departing from the scope of the present subject matter.

Another aspect provides an electronic device including a display screen configured to provide a GUI, a sensor configured to generate an indication representative of a change in environment condition about the electronic device, and a processor circuit electrically coupled to the display screen and the sensor. The processor circuit is configured to receive the indication of a change in condition of the electronic device from the sensor and select elements of the GUI of the electronic device to be modified. In various embodiments, the processor is further configured to dynamically modify the selected GUI elements globally for one or more applications, and render an output on the display screen using the modified GUI elements, to provide eye relief for a user of the electronic device and preserve electrical power for the electronic device. According to various embodiments, the electronic device includes a cellular telephone, a personal computer, and/or a tablet. Other types of electronic devices can be used without departing from the scope of the present subject matter.

A computer readable storage medium is provided that includes instructions for execution by a processor to detect a change in condition of the electronic device, select elements of a GUI of a display of the electronic device to be modified, dynamically modify the selected GUI elements globally for one or more applications, and render an output on the display using the modified GUI elements, to provide eye relief for a user of the electronic device and preserve electrical power for the electronic device. In various embodiments, detecting a change in condition of the electronic device includes detecting a change in time of day, a change geographic location, a change in device operating or power mode, and/or a request by the user. Other types of conditions can be detected without departing from the scope of the present subject matter.

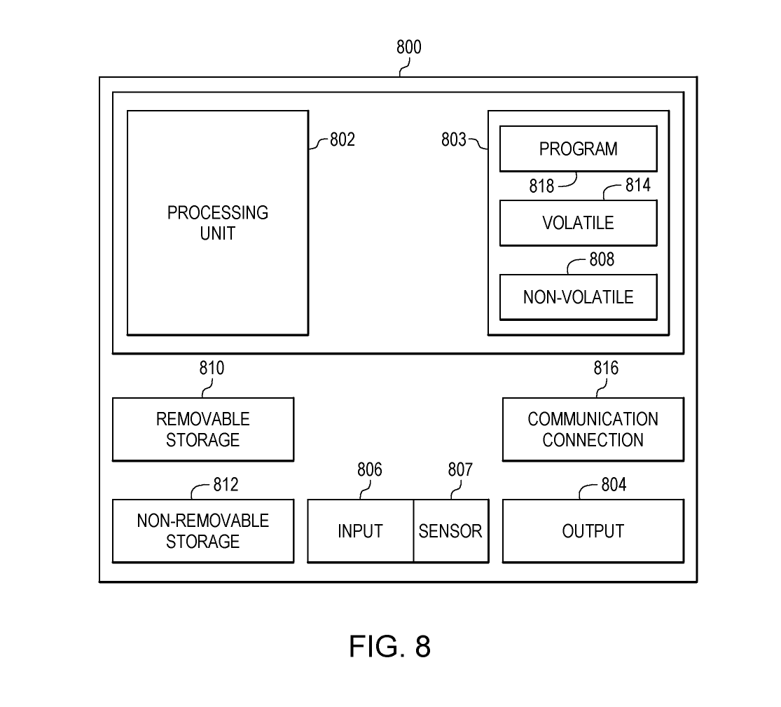

FIG. 8 is a block schematic diagram of a computer system 800 to implement the controller and methods according to example embodiments. All components need not be used in various embodiments. One example computing device in the form of a computer 800 may include a processing unit 802, memory 803, removable storage 810, and non-removable storage 812. Although the example computing device is illustrated and described as computer 800, the computing device may be in different forms in different embodiments. For example, the computing device may instead be a smartphone, a tablet, smartwatch, or other computing device including the same or similar elements as illustrated and described with regard to FIG. 8. Devices such as smartphones, tablets, and smartwatches are generally collectively referred to as mobile devices. Further, although the various data storage elements are illustrated as part of the computer 800, the storage may also or alternatively include cloud-based storage accessible via a network, such as the Internet. Various embodiments include more than one controller in the wireless network and include distributed processing to perform the methods of the present subject matter. For example, each base station in a cellular network may have a controller or controllers that can exchange messages with other controllers and control the network in a distributed fashion.

Memory 803 may include volatile memory 814 and non-volatile memory 808. Computer 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input 806, output 804, and a communication connection 816. Output 804 may include a display device, such as a touchscreen, that also may serve as an input device. The input 806 may include one or more of a touchscreen, touchpad, mouse, keyboard, camera, one or more device-specific buttons, one or more sensors 807 integrated within or coupled via wired or wireless data connections to the computer 800, and other input devices. In various embodiments, the sensor 807 can be a photodiode to sense ambient light for purposes of dynamically modifying GUI elements using the present subject matter. The sensor 807 can include a portion of a global positioning system (GPS), in various embodiments. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular (3G, 4G, LTE, beyond LTE, 5G, etc.), WiFi, Bluetooth, and other networks.

Computer-readable instructions stored on a computer-readable medium are executable by the processing unit 802 of the computer 800. A hard drive, CD-ROM, and RAM are some examples of articles including a non-transitory computer-readable medium, such as a storage device. The terms computer-readable medium and storage device do not include carrier waves. For example, a computer program 818 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 800 to provide generic access controls in a COM based computer network system having multiple users and servers.

Although some embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
detecting, via a controller, a change in condition of an electronic device having a display, wherein a table is stored in the device, the table including an indication of whether elements of a user interface (GUI) of the display are modifiable;
selecting, via the controller, a subset of elements of the GUI to be modified, wherein the subset of elements are selected based on the indication;
dynamically modifying, via the controller, the selected GUI elements globally for one or more applications of the GUI; and
rendering, via the controller, an output on the display using the modified GUI elements to provide eye relief for a user of the electronic device and preserve electrical power for the electronic device.

2. The method of claim 1, wherein the selecting of the subset of elements of the GUI to be modified includes reading an attribute of each of the elements of the GUI to determine whether to modify the element.

3. The method of claim 2, comprising setting the attribute of the element to a first prescribed value in response to determining to modify the element.

4. The method of claim 3, wherein the first prescribed value includes an indication of how the element is to be modified.

5. The method of claim 2, comprising setting the attribute of the element to a second prescribed value in response to determining to modify the element.

6. The method of claim 5, wherein the second prescribed value does not include an indication of how the element is to be modified.

7. The method of claim 2, comprising reading the attribute of the element and determining how to dynamically modify the selected GUI elements.

8. The method of claim 7, wherein dynamically modifying the selected GUI elements includes applying color remapping.

9. The method of claim 7, wherein dynamically modifying the selected GUI elements includes modifying one or more attributes of each of the selected GUI elements.

10. The method of claim 9, wherein modifying one or more attributes includes changing size of each of the selected GUI elements.

11. The method of claim 9, wherein modifying one or more attributes includes changing a background image of each of the selected GUI elements.

12. An electronic device comprising:
a display screen configured to provide a graphical user interface (GUI);
a sensor configured to generate an indication representative of a change in environment condition about the electronic device; and
a processor circuit electrically coupled to the display screen and the sensor, wherein the processor circuit is configured to:
receive the indication of a change in condition of the electronic device from the sensor wherein a table is stored in the device, the table including an indication of whether elements of the GUI are modifiable;
select a subset of elements of the GUI of the electronic device to be modified, wherein the subset of elements are selected based on the indication;
dynamically modify the selected GUI elements globally for one or more applications of the GUI; and
render an output on the display screen using the modified GUI elements to provide eye relief for a user of the electronic device and preserve electrical power for the electronic device.

13. The device of claim 12, wherein the electronic device includes a cellular telephone.

14. The device of claim 12, wherein the electronic device includes a personal computer.

15. The device of claim 12, wherein the electronic device includes a tablet.

16. A non-transitory computer readable storage medium including instructions that, when performed by processing circuitry of an electronic device, cause the electronic device to perform acts comprising:
detecting a change in condition of the electronic device, wherein a table is stored in the device, the table including an indication of whether elements of a user interface (GUI) of a display are modifiable;
selecting a subset of elements of the GUI to be modified, wherein the subset of elements are selected based on the indication;
dynamically modifying the selected GUI elements globally for one or more applications of the GUI; and
rendering an output on the display using the modified GUI elements to provide eye relief for a user of the electronic device and preserve electrical power for the electronic device.

17. The non-transitory computer readable storage medium of claim 16, wherein detecting a change in condition of the electronic device includes detecting a change in time of day.

18. The non-transitory computer readable storage medium of claim 16, wherein detecting a change in condition of the electronic device includes detecting a change geographic location.

19. The non-transitory computer readable storage medium of claim 16, wherein detecting a change in condition of the electronic device includes detecting a change in device operating or power mode.

20. The non-transitory computer readable storage medium of claim 16, wherein detecting a change in condition of the electronic device includes detecting a request by the user.
